(19) United States
(12) Patent Application Publication
(10) Pub. No.: US 2019/0049971 A1
(43) Pub. Date: Feb. 14, 2019

(54) FLIGHT DEVICE, INSTALLATION METHOD FOR INSTALLATION TARGET, AND INSTALLATION MECHANISM

(71) Applicant: Kabushiki Kaisha Toshiba, Minato-ku (JP)

(72) Inventors: Junya Tanaka, Ota (JP); Hiroshi Takahashi, Yokohama (JP)

(73) Assignee: Kabushiki Kaisha Toshiba, Minato-ku (JP)

(21) Appl. No.: 15/907,949

(22) Filed: Feb. 28, 2018

(30) Foreign Application Priority Data
Aug. 8, 2017 (JP) 2017-153414

(51) Int. Cl. G05D 1/00; B64C 39/02; G05D 1/06; G08G 5/00; B64D 1/22; B25J 15/06

(52) U.S. Cl. CPC G05D 1/0094; B64C 39/024; B25J 15/0616; G08G 5/0069; B64D 1/22; G05D 1/0607

(57) ABSTRACT

A flight device includes a flight body and includes
a fixing member capable of being fixed to a surface to be fixed;
an installation member capable of installing an installation object on the surface to be fixed;
a first direction movement member which is connected to the flight body and is capable of moving the installation member in a first direction; and
a second direction movement member which is capable of moving the installation member in a second direction intersecting with the first direction.

### CROSS-REFERENCE TO RELATED APPLICATIONS

This application is based upon and claims the benefit of priority from Japanese Patent Application No. 2017-153414, filed on Aug. 8, 2017, and the entire contents of which are incorporated herein by reference.

### FIELD

Embodiments described herein relate generally to a flight device, a method for installing an installation target, and an installation mechanism.

### BACKGROUND

In recent years, flight vehicles capable of flying in an unmanned manner by a remote control or an automatic control have been utilized in the fields such as an infrastructure inspection business, a civil engineering business, a logistics service and a disaster relief.

When performing an operation such as installation of sensors such as cameras on a ceiling or the like with an unmanned aircraft vehicle, the unmanned aircraft vehicle is more susceptible to the influence of disturbances such as wind on the way of installation, and is installed at a position deviated from a target installation position.

Especially when flying in the vicinity of the installation place such as a ceiling, since the rotor blades are more susceptible to the influence of the air current, it is difficult to maintain the posture of the flight vehicle.

Therefore, when installing an installation target using the flight vehicle, an installation mechanism for installing the installation target at an accurate position is required.

### BRIEF DESCRIPTION OF THE DRAWINGS

FIGS. 1A to 1C are diagrams illustrating a flight device according to a first embodiment;

FIG. 2 is a diagram illustrating a horizontal movement state of the flight device according to the present embodiment;

FIGS. 3A and 3B are diagrams illustrating a configuration example of a support member;

FIG. 4 is a diagram illustrating a configuration example of a vacuum pad;

FIG. 5 is a diagram illustrating a configuration example of a horizontal movement member;

FIGS. 6A and 6B are diagrams illustrating an example in which an installation member is vertically moved by a vertical movement member;

FIG. 7 is a diagram illustrating a configuration example of the vertical movement member;

FIG. 8 is a diagram illustrating a configuration example of a controller; and

FIG. 9 is a diagram illustrating an operation sequence of the flight device according to the present embodiment.

### DETAILED DESCRIPTION

Embodiments of the present invention will be described below with reference to the drawings.

Those having the same reference numerals indicate corresponding ones. It should be noted that the drawings are schematic or conceptual, and the relation between the thickness and the width of each portion, the ratio of the sizes between the portions, and the like are not necessarily the same as the actual ones. Also, even in the case of representing the same portion, the sizes and ratios of the portions may be different from each other depending on the drawing.

### (First Embodiment)

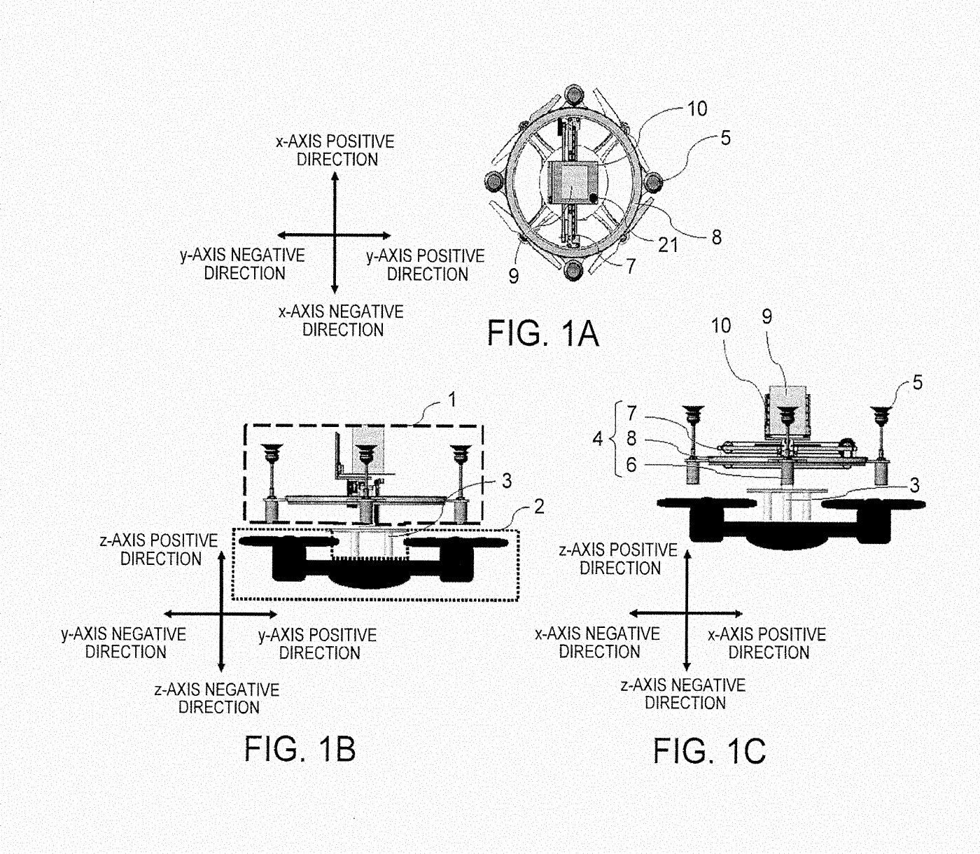

FIG. 1 is a diagram illustrating a flight device according to a first embodiment.

FIG. 1A is a diagram of the flight device according to the present embodiment as viewed from a z-axis positive direction, FIG. 1B is a diagram of the flight device according to the present embodiment as viewed from an x-axis positive direction, and FIG. 1C is a diagram of the flight device according to the present embodiment as viewed from a y-axis negative direction.

The flight device according to the present embodiment includes an installation mechanism member 1, a flight vehicle member 2, and a support member 3.

The flight vehicle member 2 (also referred to as a flight body 2) conveys the installation mechanism member 1 to a desired target position through flight, and is controlled remotely, for example, by a controller 120 described later.

The installation mechanism member 1 is a mechanism for installing the installation object at a target position when reaching the target position, and is held by the flight vehicle member 2 via the support member 3. In FIG. 1, the support member 3 is connected on a plane including the x-axis and the y-axis (that is, a horizontal plane).

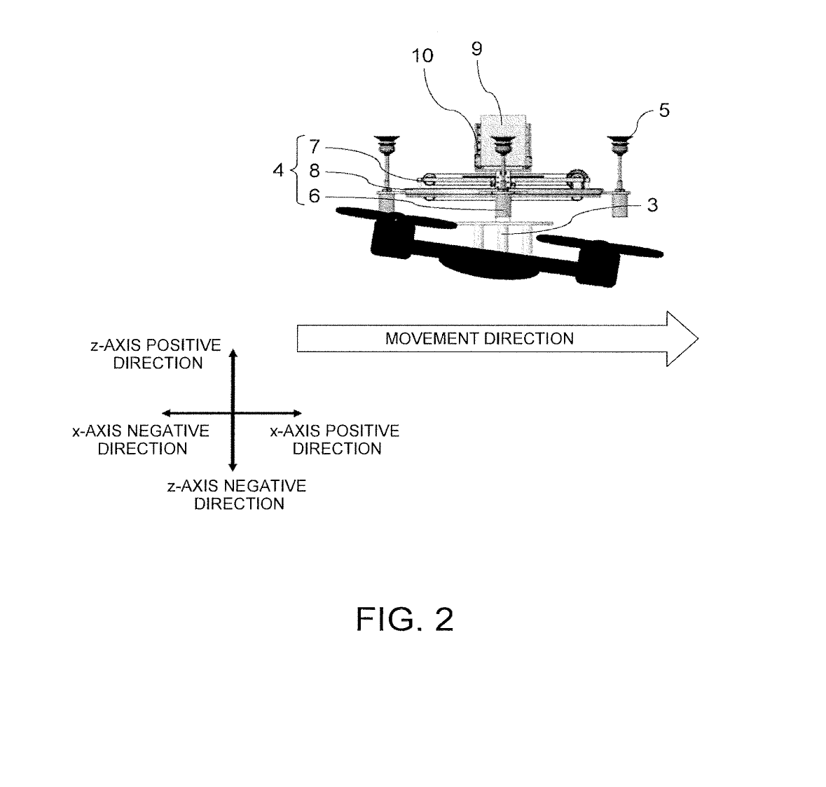

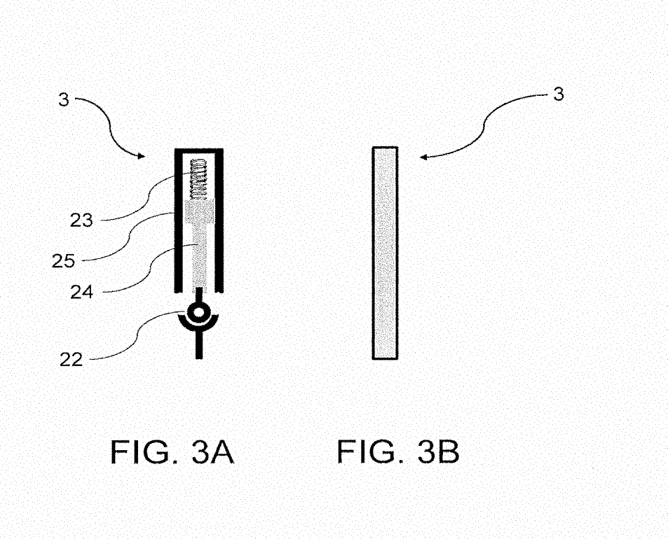

As illustrated in FIG. 2, when the flight vehicle member 2 moves in a horizontal direction, it is necessary to tilt the airframe in a movement direction, but the installation mechanism member 1 is preferably kept horizontal. Therefore, it is desirable that the support member 3 has elastic properties. FIG. 3A is a diagram illustrating an example in which the support member 3 can be elastically expanded and contracted in the z-direction by a spring 23. A ball joint 22 is connected to a support column 24, and the spring 23 is connected to the other end thereof. The spring 23 and the support column 24 are covered with a case 25. The support member 3 can be bent by the ball joint 22. FIG. 3B is a diagram illustrating an example in which a cylindrical member is made up of an elastic material.

The installation mechanism member 1 includes an installation member 10 which installs an installation object 9, a movement member 4 which moves the installation member 10 to perform an installation operation, a fixing member 5 (fixer) provided at an end portion of the movement member 4 for being temporarily fixed to a ceiling or the like which is a surface to be fixed, and a recognition unit 21 which recognizes the target position. Among them, the movement member 4 includes a vertical movement member 6 (also referred to as a first direction movement member or a first direction mover) which vertically moves the installation member 10, a horizontal movement member 7 (also referred to as a second direction movement member or a second direction mover) which horizontally moves the installation member 10, and a revolving member 8 (also referred to as a rotation member or a rotor) around which both ends of the horizontal movement member 7 revolve on a plane including the x-axis and the y-axis (also referred to as a horizontal plane or a plane including the second direction). Here, in the present embodiment, the vertical movement is a movement in the first direction, and the horizontal movement is a movement in the second direction. Also, the second direction is a direction intersecting with the first direction, and the intersection is almost orthogonal.

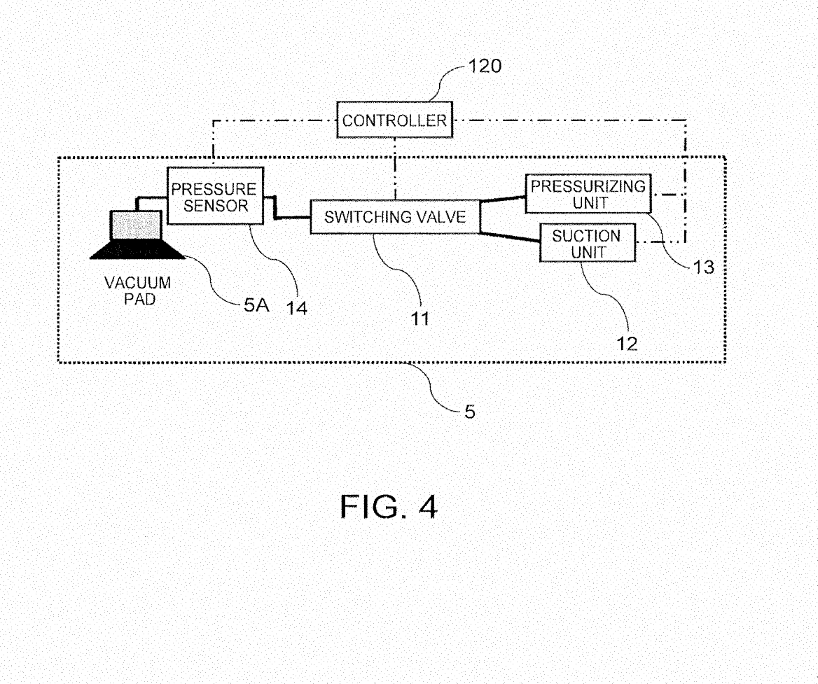

The fixing member 5 is provided with a fixing member so as to be fixed to a ceiling or the like which is a surface to be fixed only at least during the operation period at which the positioning is performed. In the present embodiment, four fixing members 5 are illustrated. A vacuum pad 5A is used as the fixing member 5. FIG. 4 is a diagram illustrating a configuration of the fixing member 5. The vacuum pad 5A abuts against the surface to be fixed, the pressure is lowered by sucking a sealed space formed by the surface to be fixed and the vacuum pad, and the vacuum pad 5A can be fixed to the surface to be fixed. The suction or pressurizing operation of the vacuum pad 5A is remotely controlled by the controller 120.

A tube is attached to the vacuum pad 5A on the side opposite to the side of the surface to be fixed which is fixed. The other end of the tube attached to the vacuum pad 5A is attached to a switching valve 11 via the pressure sensor 14. Further, the sensor on the tube path detects the fluid state and may be provided with a flow rate sensor without being limited to the pressure sensor 14, or may be provided with both the pressure sensor 14 and the flow rate sensor. Further, two tubes may be additionally attached to the switching valve in a forked shape. On one hand, the other ends of the two tubes are attached to the pressurizing unit 13 which increases the pressure of the sealed space formed by the surface to be fixed and the vacuum pad. On the other hand, the other ends of the two tubes are attached to the suction unit 12 that lowers the pressure of the sealed space formed by the surface to be fixed and the vacuum pad. Further, the controller 120 controls the pressure sensor 14, the switching valve 11, the pressurizing unit 13, and the suction unit 12. The controller 120 controls the pressure of the sealed space formed when the vacuum pad is fixed to the surface to be fixed. In the case of sucking the fluid from the vacuum pad 5A to lower the pressure, after the controller 120 controls the switching valve 11 such that the vacuum pad and the suction unit 12 communicate with each other, the controller 120 performs a control for operating the suction unit 12. As a result, the pressure of the sealed space sucked via the tube lowers, and the vacuum pad 5A is fixed to the fixing surface. In the case of supplying the fluid to the vacuum pad to increase the pressure, after the controller 120 controls the switching valve such that the vacuum pad and the pressurizing unit 13 communicate with each other, the controller 120 performs a control for operating the pressurizing unit 13. As a result, the pressure of the sealed space sucked via the tube increases, and the vacuum pad 5A is peeled off from the fixing surface. It should be noted that the operation start timing of the suction unit 12 and the pressurizing unit 13 is not limited to the timing after switching of the switching valve 11, but may be the timing before switching of the switching valve 11. A compressor may be used as the pressurizing unit 13. A vacuum pump may be used as the suction unit 12. Instead of the vacuum pump, a device which generates a negative pressure by combining the pressurizing unit 13 and a vacuum generator may be used. Further, the switching valve 11 may be a valve of a type operated by atmospheric pressure or a valve of electrically driven type. The tube is desirably a flexible tube, and is desirably not to collapse due to suction and not to cause expanding rupture due to pressure application. When the pressure sensor 14 detects the pressure of the sealed space formed by the surface to be fixed and the vacuum pad, the controller 120 determines whether or not the sealed space is damaged and determines the vacuum state of the vacuum pad 5A. Further, when a flow rate sensor is disposed instead of the pressure sensor, the flow rate sensor detects the flow rate flowing into each of the vacuum pad and the sealed space, thereby determining the vacuum state of the vacuum pad 5A. The fixing member is not limited to the above-described vacuum pad, and a permanent magnet, an electromagnet, a suction cup, an adhesive pad, an adhesive, an electrostatic attraction member, a claw member, and other tools capable of being fixed to and detached from the surface to be fixed may be used, or two or more of these tools may be used in combination.

The installation object 9 is, for example, a sensor, or the like. The installation object 9 includes a fixing member on a side opposite to the installation member 10 side (that is, a side of the surface to be fixed) so as to be fixed to a ceiling or the like which is the surface to be fixed. As the fixing member provided on the installation object 9, a permanent magnet, an electromagnet, a suction cup, an adhesive pad, an adhesive, an electrostatic attraction member, a claw member, and other tools capable of being fixed to and detached from the fixing target may be used, or two or more of these tools may be used in combination. Besides, in the present embodiment, the number of the fixing members 5 is four, but may be one or more.

The recognition unit 21 is for recognizing the target position, and is, for example, a camera.

Each of the horizontal movement member 7, the vertical movement member 6, and the revolving member 8, which are constituent elements of the movement member 4, can switch two states of a movement state and a movement fixed state. Further, movement amount detection sensors A, B, and C (not illustrated) for detecting the movement amounts of the horizontal movement member 7, the vertical movement member 6, and the revolving member 8 are provided. The movement state indicates a passively movable state (movable, by the flight vehicle member 2), and the movement fixed state indicates an immovably fixed state. Switching between the movement state and the movement fixed state is attained by utilizing, for example, a sliding state and a non-sliding state of an electromagnetic brake. Further, for example, the situation in which the horizontal movement member 7 is in a movement state, is a state in which the installation member 10 is passively and horizontally movable. The situation in which the horizontal movement member 7 is in a fixed state, is a state in which the installation member 10 does not move horizontally even when disturbance acts on the installation member 10.

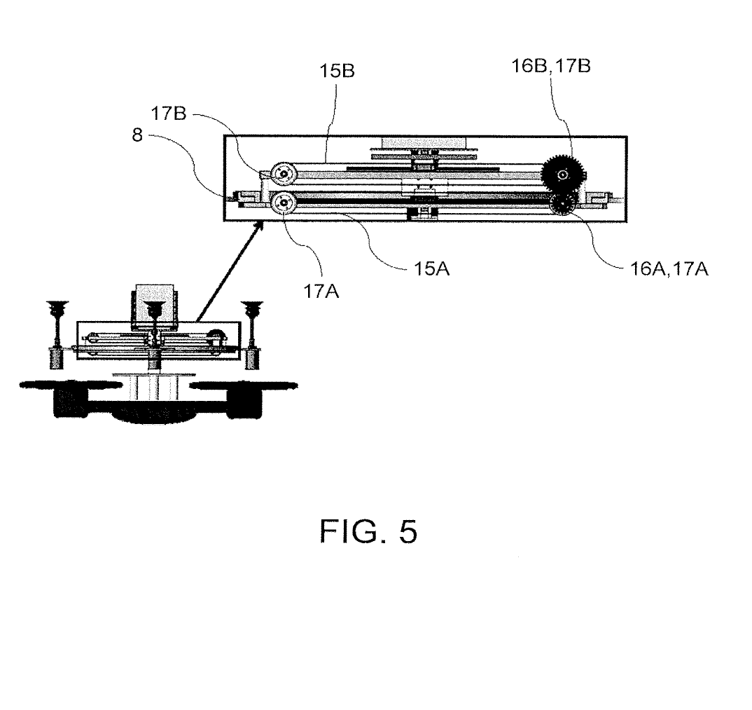

As illustrated in FIG. 5, for example, the horizontal movement member 7 includes a belt 15A, a belt 15B, a gear 16A, a gear 16B, a pulley 17A, and a pulley 17B. Both ends of the belt 15A on the x-axis are connected to the pulley 17A, 17A, and the belt 15A is laid in an annular shape. The gear 16A is coaxially connected to one pulley 17A. In this embodiment, the gear 16A is provided on the z-axis negative direction side from the gear 16B. When the horizontal movement member 7 is in the movement state, as the flight vehicle member 2 moves in the horizontal movement direction, the horizontal movement member 7 operates. The operation of the horizontal movement member 7 will be described in detail. The belt 15A connected to the vertical movement member 6 moves with the horizontal movement of the vertical movement member 6 disposed on the flight vehicle member 2. As a result, the pulley 17A connected to the belt 15A rotates, and the gear 16A rotates. Further, the gear 16A engages with the gear 16B, and the driving force is transmitted from the gear 16A to the gear 16B. The movement amount detection sensor A is installed on the gear 16B, and detects the movement amount of the installation member 10 from the rotation amount of the gear 16B. Both ends of the belt 15B on the x-axis are connected to the pulley 17B, 17B, and the belt 15B is laid in an annular shape. The gear 16B is coaxially connected to one pulley 17B. Further, in the z-axis positive direction, the installation member 10 is connected to the belt 15B. At this time, since the installation method for the installation member 10 is a linear guide, the installation member 10 horizontally moves with the movement of the belt 15B, while maintaining the straightness. As described above, the horizontal movement member 7 generates the horizontal movement output for the installation member 10 with respect to the horizontal movement input of the vertical movement member 6.

Further, by adjusting the diameter ratio between the gear 16A and the gear 16B, it is possible to change the movement amount of the installation member 10 with respect to the movement amount of the flight vehicle member 2. For example, FIG. 5 is a diagram illustrating an example in which the movement amount of the installation member 10 is smaller than the movement amount of the flight vehicle member 2. Since the ratio is 1:2, the installation member 10 moves by a movement amount of ½ with respect to the horizontal movement amount of the vertical movement member 6. At this time, since the gear 16A and the gear 16B are formed in a pair, the installation member 10 moves in the opposite direction with respect to the horizontal movement direction of the vertical movement member 6. The horizontal movement member 7 is brought into a movement fixed state, by abutment of the claw portions against the teeth of the gear 16A or the gear 16B. On the other hand, the horizontal movement member 7 is brought into the movement state, by disengagement of the claw portion from the teeth of the gear 16A or the gear 16B.

The installation member 10 may move in the same direction as the horizontal movement of the vertical movement member 6. The pulley 17A and the pulley 17B shown in FIG. 5 rotate in opposite directions each other. Therefore, in the case that the vertical movement member 6 is connected to a lower belt of the belt 15A and the installation member 10 is connected to an upper belt of the belt 15B, the installation member 10 moves the same direction as the horizontal movement of the vertical movement member 6. On the other hand, if the installation member 10 is connected to the lower belt of the belt 15B, the installation member 10 moves in the reverse direction. Besides, the connection methods of the vertical movement member 6 and the installation member 10 to the horizontal movement member 7 are not limited thereto.

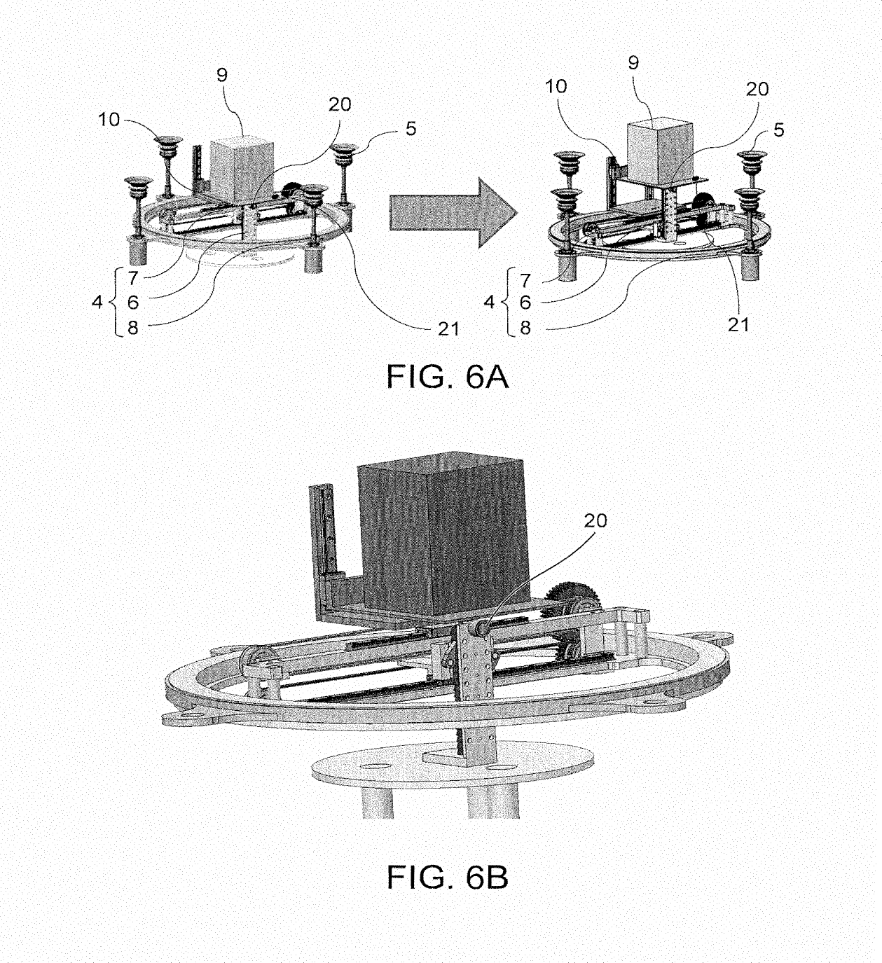

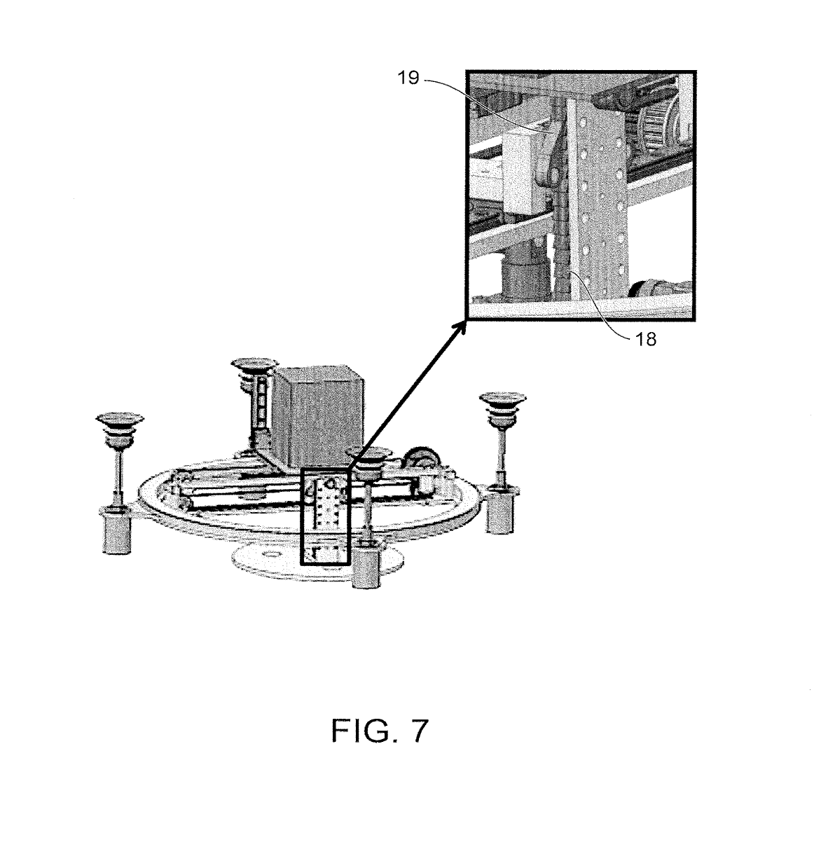

The vertical movement member 6 is connected to the belt 15A and horizontally moves passively by the horizontal movement of the flight vehicle member 2. Further, as illustrated in FIG. 6A, the vertical movement member 6 vertically moves the installation member 10 by the vertical movement of the flight vehicle member 2. The vertical movement member 6 is in the movement fixed state before the fixing member 5 is fixed to the surface to be fixed, and the vertical movement member 6 is in the movement state after the fixing member 5 is fixed. In the movement state, as the flight vehicle member 2 moves in the z-axis positive direction, the vertical movement member 6 moves the installation member 10 in the z-axis positive direction. At this time, as shown in FIG. 6B, a passive roller 20 is disposed at the end portion on the installation member 10 side of the vertical movement member 6, and the passive roller 20 and the installation member 10 are made to abut against each other and are pressed. Since the passive roller 20 is disposed, even if the passive roller 20 and the installation member 10 are in the state of abutting against each other, the vertical movement member 6 can move horizontally. A movement amount detection sensor B is installed on the passive roller 20, and the movement amount detection sensor B detects the movement amount of the installation member 10 from the rotation amount of the passive roller 20. Further, in the present embodiment, as illustrated in FIG. 7, when the claw portion 19 abuts against the portion of the teeth of rack 18 of the vertical movement member 6, the movement fixed state is obtained.

The revolving member 8 is made up of an annular member connected to both ends of the horizontal movement member 7. Since both ends of the horizontal movement member 7 revolves on the annular member, the installation member 10 and the vertical movement member 6 can move not only on the x-axis but also on the y-axis. Before the fixing member 5 is fixed to the surface to be fixed, the revolving member 8 is in the movement fixed state, and is brought into the movement state after the fixing member 5 is fixed. When both ends of the horizontal movement member revolve by the revolving member 8, the flight vehicle member 2 can move on the plane including the x-axis and the y-axis. Further, in the present embodiment, wheels are provided at both ends of the horizontal movement member 7. A movement amount detection sensor C is installed on the wheel, and the movement amount detection sensor C detects the movement amount of the installation member 10 from the rotation amount of the wheel. The revolving member 8 includes a rail, and both ends of the horizontal movement member 7 revolve with the movement, for example, rotation, of the flight vehicle member 2. The revolving member 8 has a movement fixing mechanism. Before fixing the fixing member 5, it is possible to fix the wheels by the movement fixing mechanism so as not to move. For example, the movement fixing mechanism is an electromagnetic brake. Further, without being limited to the wheels, a large-diameter bearing may be used to support the horizontal movement member 7 to revolve on the inner surface of the bearing.

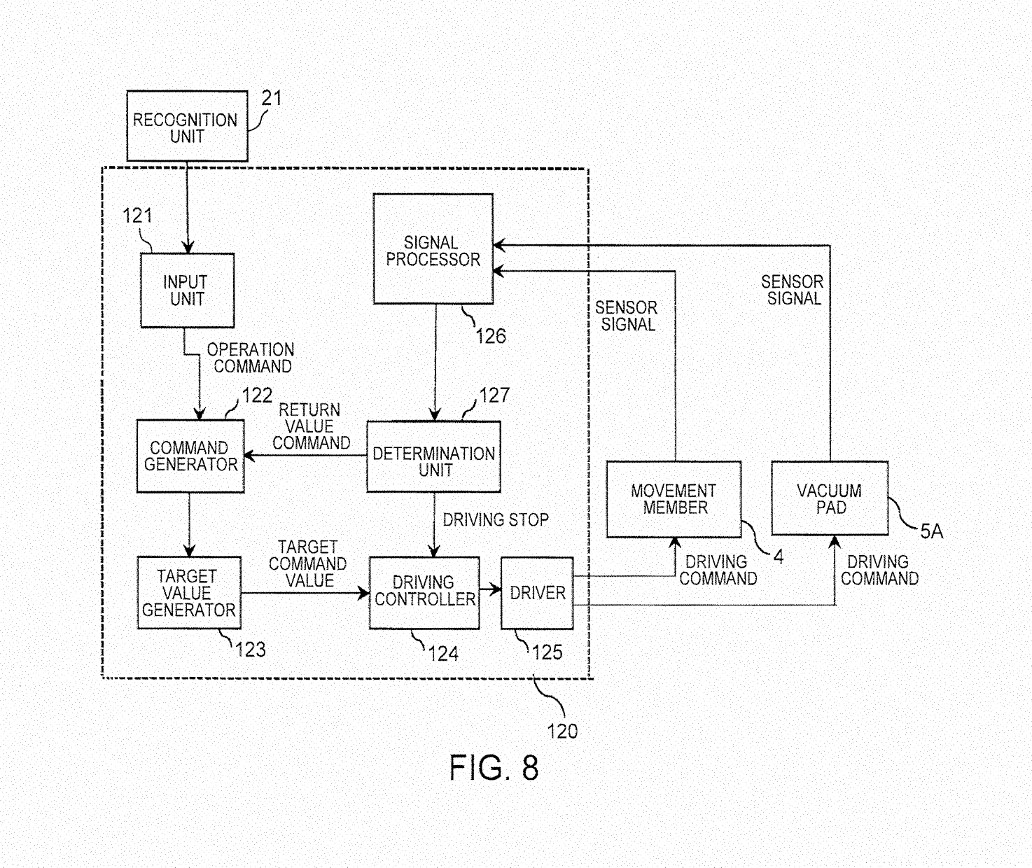

FIG. 8 is a diagram illustrating the configuration of the controller 120.

The controller 120 serves to remotely control the flight device according to the present embodiment. In order to allow the autonomous operation, the controller 120 may be provided inside the flight device. The controller 120 may be provided outside the flight device.

The controller 120 includes an input unit 121, a command generator 122, a target value generator 123 that generates a target command value, a drive controller 124, a driver 125, a signal processor 126, and a determination unit 127.

The input unit 121 is a part to which the operation command information of the flight device is input on the basis of the recognition result of the target position of the recognition unit 21. The input to the input unit 121 may be directly input, for example, with a touch panel, a monitor, or the like, or may be input from a remote location wirelessly or by wire. When communicating wirelessly, the input unit 121 functions as a communication unit. When functioning as the communication unit, the input unit 121 receives the operation command information from an external computer or a server. Although it is preferable to use a wireless communication device, the communication device may be configured as a communication network. As the communication network, it is possible to use, for example, the Internet, an Intranet, an Extranet, a LAN, an ISDN, a VAN, a CATV communication network, a virtual private network, a telephone network, a mobile communication network, a satellite communication network or the like. As the transmission medium which forms the communication network, although there is no particular limitation, it is possible to use, for example, a wired medium such as IEEE 1394, USB, a power-line carrier, a cable TV line, a telephone line, or an ADSL line, and a wireless medium such as infrared ray such as an IrDA and a remote controller, Bluetooth (registered trademark), 802.11 wireless, an HDR, a mobile phone network, a satellite line, and a terrestrial digital network. The input unit 121 transmits the operation command information of the flight device to the command generator 122. Alternatively, the input unit 121 may be provided with a microphone, and can input the operation command information of the flight device by voice of a worker (user).

The command generator 122 generates an operation procedure required for each operation process as an operation command, on the basis of the operation command information. The command generator 122 generates the operation mode information corresponding to the operation command to be executed. The operation command is a command related to a series of operations of the flight device, and is, for example, information as a program. The operation mode information is information on individual operations. For example, the operation mode information is an operation of “raising” or “lowering” the flight device. The command generator 122 has a storage that stores the operation mode information and the like.

Attribute data such as a shape or a material of the surface to be adsorbed, which is a target of installation, is also stored in the storage in advance. Examples of the storage may include a disk system including a magnetic disk such as a hard disk or an optical disk such as a CD-ROM/DVD/CD-R, a card system such as an IC card (including a memory card)/an optical card, or a semiconductor memory system such as mask ROM/EPROM/EEPROM/flash ROM. The command generator 122 outputs the operation command to the target value generator 123. Further, the command generator 122 joins each operation mode of the operation command with the actual operation information stored in the storage, and outputs it to the determination unit 127.

The operation command for the flight device is input to the target value generator 123 from the command generator 122. The target value generator 123 generates a target command value for the flight device from the input operation command. The target command value is output to the drive controller 124.

The target command value of the flight device is input to the drive controller 124 from the target value generator 123, and the drive controller 124 generates drive command information for driving the flight device in accordance with the target command value. The drive command information is output to the driver 125.

The drive command information is input to the driver 125 from the drive controller 124 to generate the driving output. The flight device receives the driving output (driving command) from the driver 125, and operates an actuator or the like to adjust the driving amount. A solenoid for switching the movement fixed state, a brake, or the like can be used as the actuator. The switching valve 11, the pressurizing unit 13, and the suction unit 12 are driven by the driving output from the driver 125. Further, the horizontal movement member 7, the vertical movement member 6, and the revolving member 8, that is, the movement member 4 change the movement state or the movement fixed state at appropriate timings, by the driving output of the driver 125, and accurately move the installation object 9 at the target position.

The signal processor 126 receives signals from the movement amount detection sensor of the movement member 4 and the pressure sensor 14 of the vacuum pad 5A, and performs the signal amplification processing, the analog-digital conversion processing, and the like on the sensor signal.

The sensor signal converted by the signal processor 126 is input to the determination unit 127. The determination unit 127 determines adjustment or the like of the driving amount of the flight device in accordance with the sensor signal. The determination unit 127 receives the operation information of the flight device corresponding to the operation command from the command generator 122. The determination unit 127 compares the operation information with the information according to the sensor signal. On the basis of the comparison result, the determination unit 127 generates the operation commands such as stoppage of the driving of the flight device or correction of the attitude of the flight device according to the fixing condition. The determination unit 127 outputs to the command generator 122 a return value command for modifying the operation command. By the return value command, the command generator 122 can correct the operation command and execute the processing operation suitable for the operation command information which is input by the input unit. This improves the reliability and certainty of the operation of the flight device.

The command generator 122, the target value generator 123, the drive controller 124, the signal processor 126, and the determination unit 127 are provided with a central processing unit (CPU), a memory, an auxiliary storage unit, or the like, and execute program or the like. Further, all or a part thereof may be attained, using hardware such as an application specific integrated circuit (ASIC), a programmable logic device (PLD), and a field programmable gate array (FPGA). At this time, the fixing member 5 is assumed to be the above-described vacuum pad.

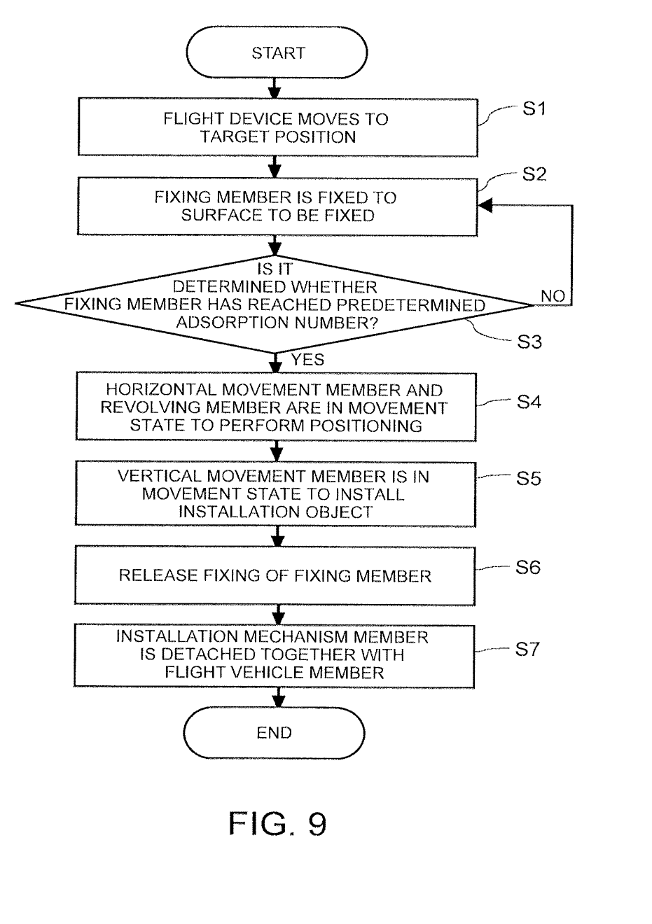

FIG. 9 is a diagram illustrating an operation sequence of the flight device according to the present embodiment.

The flight device according to the present embodiment moves to the target position (step S1). At this time, the flight device approaches at a positioning accuracy to such an extent that the target installation position of the installation object 9 falls within the movement range of the movement member 4.

The fixing member 5 of the flight device according to the present embodiment is fixed to the surface to be fixed (step S2).

The determination processing unit (determination unit) determines whether the fixing member 5 has reached a predetermined fixing number (predetermined vacuum number) (step S3).

By releasing the movement fixed state of the horizontal movement member 7 or the revolving member 8 at a suitable timing, at least one mechanism of the horizontal movement member 7 or the revolving member 8 moves together with the flight vehicle member 2, and the installation object 9 moves to perform the positioning (step S4).

By releasing the movement fixed state of the vertical movement member 6 at a suitable timing, the installation object 9 placed on the installation member 10 passively moves vertically, together with the vertical movement of the flight vehicle member 2. The installation object 9 is installed on the surface to be fixed of the target position (step S5).

After installing the installation object 9 on the surface to be fixed, the controller 120 releases the fixing of the fixing member 5 (step S6). In the case of using the above-described vacuum pad 5A, the controller 120 controls the switching valve 11 and the pressurizing unit 13 to pressurize the sealed space formed by the fixing surface and the vacuum pad, thereby releasing the fixed state.

The flight vehicle member 2 is detached together with the installation mechanism member 1, while leaving only the installation object 9 (step S7).

Besides, the computer or the embedded system according to the present embodiment is for executing each process according to the present embodiment on the basis of a program stored in a recording medium, and may include a single device such as a personal computer and a microcomputer, and a system in which a plurality of devices is connected to each other via a network. In addition, the computer in the present embodiment is not limited to a personal computer, but also includes an arithmetic processor, a microcomputer, and the like included in the information processing device, and collectively refers to devices and apparatuses that can achieve the functions according to the present embodiment by a program.

According to the embodiment, a flight device in which an installation object is installed at an accurate position, using an unmanned aircraft vehicle, can be provided.

The flight device according to the present embodiment can accurately position the installation object 9 at the target position, by moving the installation object 9 vertically and horizontally using the installation mechanism. Further, since the installation mechanism uses the movement of the flight vehicle member 2 as a driving force, an engine or the like is not required when performing the positioning, and it is possible to reduce the size and weight.

As illustrated in FIG. 9, the fixing member 5 is detached from the surface to be fixed. Alternatively, the fixing member 5 may be detached from the flight device in step S6. Since it is not necessary for the flight device to stand by until the installation object 9 is fixed to the surface to be fixed with an adhesive or the like, the flight device can be used for other operations and operability can be improved.

Further, the first direction includes directions other than the vertical direction, and may be, for example, a horizontal direction or an oblique direction. Further, the second direction includes directions other than the horizontal direction, and may be, for example, a vertical direction or an oblique direction. Further, the movement member 4 can be attached to the flight device in various directions. For example, when the surface to be fixed is located in the horizontal direction, the surface to be fixed may be installed so that the fixing member 5 faces the horizontal direction. Further, when the surface to be fixed is inclined with respect to the plane including the x-axis and the y-axis, the surface to be fixed may be installed obliquely.

While several embodiments of the present invention have been described, these embodiments have been presented by way of example and are not intended to limit the scope of the invention. This embodiment can be provided in various other forms, and various omissions, substitutions, and modifications can be made within the scope that does not depart from the gist of the invention. This embodiment and its variations are included in the invention described in the claims and the equivalent scope thereof, in the same manner as being included in the scope or gist of the description.

What is claimed is:

1. A flight device including a flight body, the flight device comprising:
a fixing member capable of being fixed to a surface to be fixed;
an installation member capable of installing an installation object on the surface to be fixed;
a first direction movement member which is connected to the flight body and is capable of moving the installation member in a first direction; and
a second direction movement member which is capable of moving the installation member in a second direction intersecting with the first direction.

2. The flight device according to claim 1, wherein the second direction movement member s connected to the installation member and the first direction movement member.

3. The flight device according to claim 1, wherein the first direction movement member moves the installation member in the first direction in accordance with the movement of the flight body in the first direction, and the second direction movement member moves the installation member in the second direction in accordance with the movement of the flight body in the second direction.

4. The flight device according to claim 1, wherein the first direction movement member moves the installation member in a vertical direction in accordance with the movement of the flight body in the vertical direction, and the second direction movement member moves the installation member in a horizontal direction in accordance with the movement of the flight body in the horizontal direction.

5. The flight device according to claim 1, further comprising:
a rotation member which has an annular member supporting both ends of the second direction movement member, the rotation member enables movement of the flight body and the installation member on a plane including the second direction by revolving both ends of the second direction movement member.

6. The flight device according to claim 5, wherein the rotation member rotates the second direction movement member in accordance with the rotation of the flight vehicle.

7. The flight device according to claim 1, wherein the fixing member is detachable from the surface to be fixed, and
after installing the installation object on the surface to be fixed, the fixing member is detached from the surface to be fixed, and the flight device is detached.

8. The flight device according to claim 1, wherein the fixing member is detachable from the flight device, and
after installing the installation object on the surface to be fixed, the flight body is detached from the surface to be fixed, while fixing the fixing member to the surface to be fixed.

9. A method for installing an installation object, using a flight device including a flight body, the method comprising:
fixing a fixing member to a surface to be fixed;
after fixing the fixing member, moving the flight body in a second direction to move the installation object to a target position in the second direction; and
after moving the installation object in the second direction, moving the flight body in a first direction to install the installation object at the target position.

10. The method according to claim 9, wherein the flight body is movable on a plane including the second direction after the fixing member is fixed to the surface to be fixed.

11. The method according to claim 9, wherein, after installing the installation object on the surface to be fixed, the fixing member is detached from the surface to be fixed and the flight device is detached.

12. The method according to claim 9, wherein after installing the installation object on the surface to be fixed, the flight body is detached, while the fixing member is fixed to the surface to be fixed.

13. An installation mechanism attached to a flight body, comprising:
a fixing member capable of being fixed to a surface to be fixed;
an installation member capable of installing an installation object;
a first direction movement member which is connected to the flight body and is capable of moving the installation member in a first direction; and
a second direction movement member which is capable of moving the installation member in a second direction intersecting with the first direction after the fixing member is fixed to the surface to be fixed.

14. The installation mechanism according to claim 13, wherein the first direction movement member moves the installation member in the first direction in accordance with the movement of the flight body in the first direction, and
the second direction movement member moves the installation member in the second direction in accordance with the movement of the flight body in the second direction.

15. The installation mechanism according to claim 13, further comprising:
a rotation member which has an annular member supporting both ends of the second direction movement member, the rotation member enables movement of the flight body and the installation member on a plane including the second direction by revolving both ends of the second direction movement member.
